(19) United States
(12) Patent Application Publication
(10) Pub. No.: US 2014/0124999 A1
(43) Pub. Date: May 8, 2014

(54) CLAMPING SYSTEM AND METHOD

(71) Applicant: Arthur N. Foss, Seattle, WA (US)

(72) Inventor: Arthur N. Foss, Seattle, WA (US)

(21) Appl. No.: 13/668,076

(22) Filed: Nov. 2, 2012

(51) Int. Cl. B25B 5/16

(52) U.S. Cl. CPC B25B 5/163
USPC 269/276; 29/428

(57) ABSTRACT

The disclosure is directed to a clamping system, method, and apparatus. Th disclosed embodiments may be used to increase the efficiency and effectiveness of clamping work pieces during gluing operations. Generally stated, a clamping pad includes a magnet disposed within the core of the clamping pad. Alternatively, a non-abrasive magnetic material may be used on the surface of the clamping pad.

### RELATED APPLICATIONS

This patent claims the benefit of and priority to co-pending U.S. Provisional Patent Application No. 61/554,776 filed on Nov. 2, 2011, entitled Clamping System and Method.

### TECHNICAL FIELD

The present invention is directed to a clamping system, method, and apparatus. Generally stated, embodiments of the invention may be used to increase the efficiency and effectiveness of clamping work pieces during gluing operations.

### SUMMARY OF THE INVENTION WITH BACKGROUND INFORMATION

Generally stated, the present invention provides a pad for use in clamping, such as is frequently done in woodwork or shopwork, to insulate the clamp from the object being clamped. The pad is soft relative to the clamp and helps prevent scratching of the object by the clamp. The pad is embedded with a magnet of sufficient strength to impart a magnetic field that extends beyond the thickness of the pad. In this way, the pad may be very easily attached to the clamp with almost no effort, thereby simplifying the clamping process.

### BRIEF DESCRIPTION OF THE DRAWINGS

FIG. 1 is a perspective, exploded view of one embodiment of the pad.

FIG. 2 is a perspective, un-exploded view of the one embodiment of the pad.

FIG. 3 is side view of the one embodiment of the pad.

FIG. 4 is a top view of the one embodiment of the pad.

FIG. 5 is a side view of an embodiment of the pad being used in a clamp to hold a work piece.

FIG. 6 is a side view of a storage case on which multiple pads may be stored.

FIG. 7 is a top view of a storage case on which multiple pads may be stored.

FIG. 8 is an end view of multiple clamps being used to clamp a workpiece.

FIG. 9 is a side view of another clamping process using embodiments of the pad.

FIG. 10 is an alternative view of features of one embodiment of the pad.

FIG. 11 includes multiple views of an alternative embodiment of the pad.

### DETAILED DESCRIPTION OF EMBODIMENTS OF THE INVENTION

Embodiments of the invention will now be disclosed with reference to the attached figures as described below. These embodiments are illustrative only, and are not exhaustive of the many means and mechanisms by which the invention may be implemented.

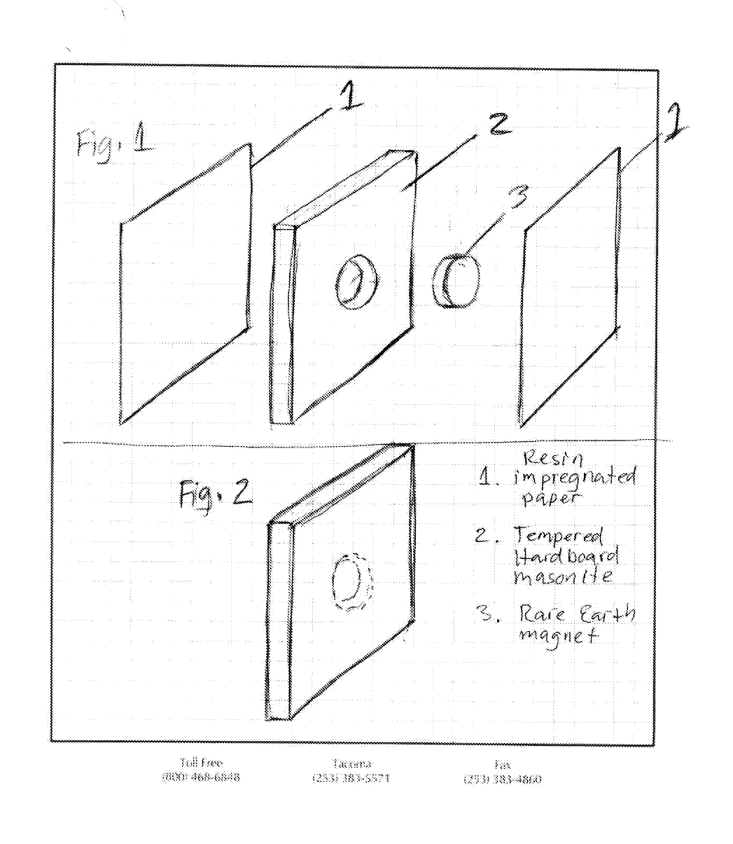

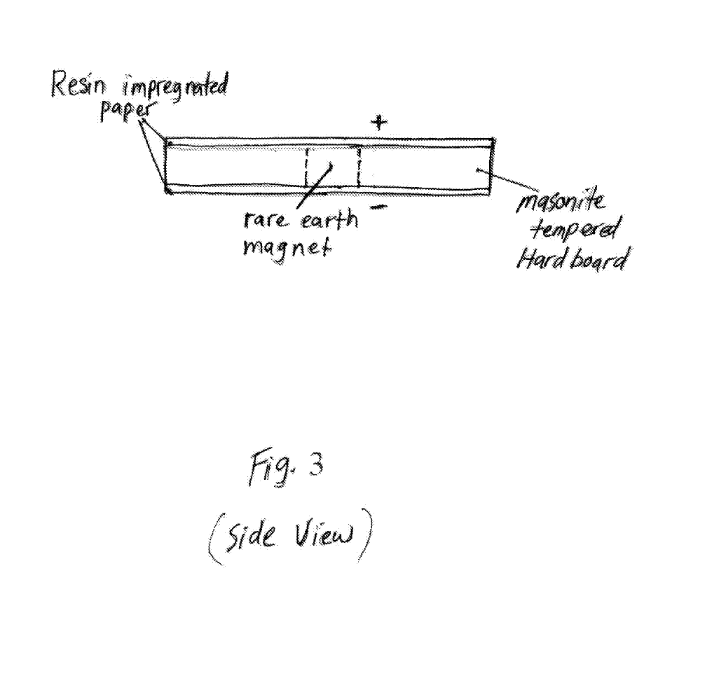

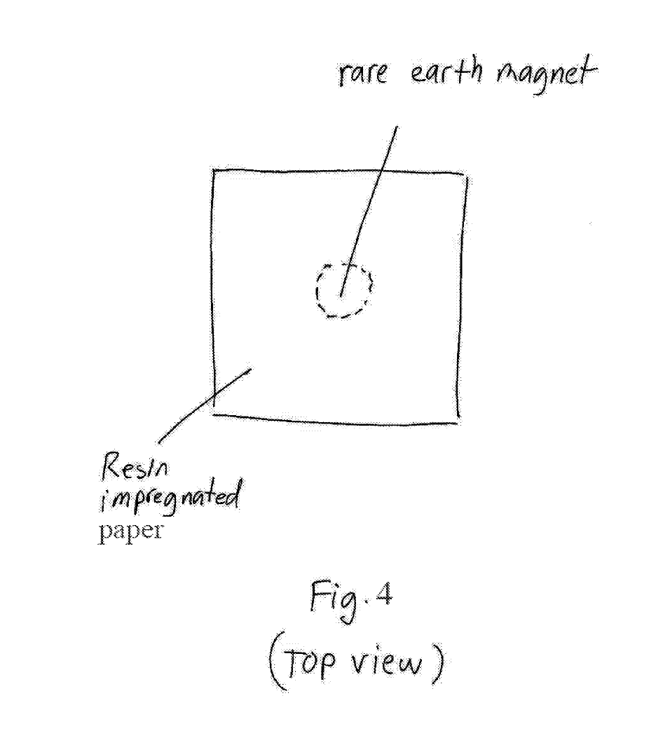

In one embodiment, the present inventive system comprises a plurality of clamp pads. Each clamp pad is stackable and magnetic. In the embodiment shown in FIGS. 1, 2, 3, and 4, each clamp pad comprises a block of masonite-tempered hardboard having layers of resin-impregnated paper on the top and bottom sides of the block. Embedded within the block is a rare earth magnet having a positively charged side and a negatively charged side. In this disclosure, the “top side” of the clamp pad is the side that is aligned with the positively charged side of the rare earth magnet, and the “bottom side” is the side that is aligned with the negatively charged side of the rare earth magnet. The top side of each block, the bottom side, or both, may be marked to indicate magnetic polarity. Any other type of magnets, including without limitation ferrite ceramic magnets, may be used in connection with the present inventive system, method, and apparatus. Aside from masonite-tempered hardboard, any relatively rigid material may be used in the fabrication of the block for each clamp pad. Aside from resin-impregnated paper, any material with a firm, smooth, slick surface may be affixed to the top and bottom sides of each block.

In one embodiment, the clamp pad dimensions may be 2.125 inches×2.125 inches×0.25 inches. The core substrate of each clamp pad may be 3/16 inch thick (0.1875 inch thick) tempered hardboard. The surface material may be 1/32 inch thick (0.03125 inch thick) resin-impregnated paper. The magnet in each clamp pad may be a Rare Earth Disc Neodymium N42, ⅜ inches (0.375 inches)× 3/16 inches (0.1875 inches). Each magnet may have a strength of 7 pounds pull force. The surface top coating may be clear conversion varnish.

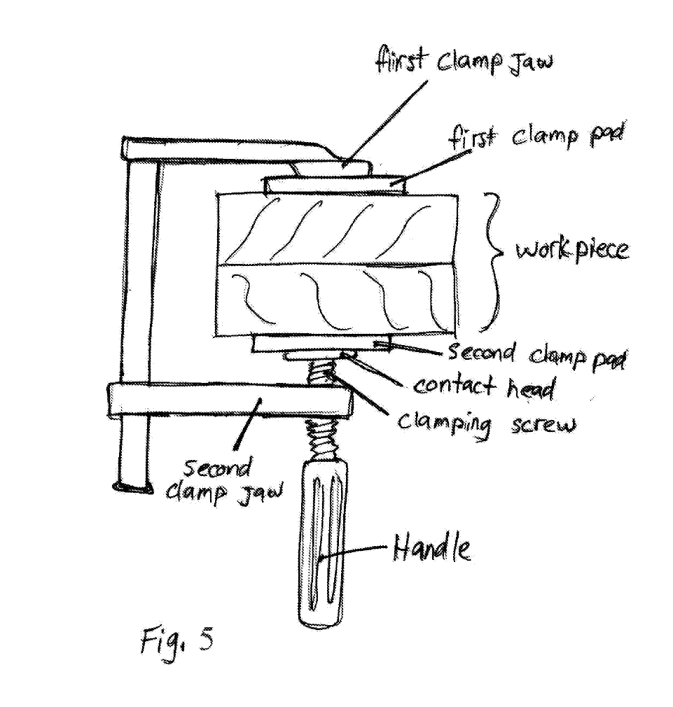

One or more clamp pads in the plurality of clamp pads may be used with a clamp. The clamp may be any device with ferrous contact surfaces which is capable of holding a work piece, including without limitation a C-clamp or a bar clamp. In the embodiment shown in FIG. 5, there is a C-clamp having a first clamp jaw and a second clamp jaw. A contact head is attached to a clamping screw and a handle. The clamping screw passes through a hole in the second clamp jaw, thereby allowing the handle to be turned to move the contact head closer to or further away from the second clamp jaw. In the embodiment shown in FIG. 5, a first clamp pad is placed in contact with the ferrous contact surface of the first clamp jaw. A second clamp pad is placed in contact with the ferrous contact surface of the contact head. This allows a work piece to be held between the first clamp pad and second clamp pad without the work piece making direct contact with either the first clamp jaw or the contact head.

In other embodiments, more than one clamp pad may be placed in contact with the ferrous contact surface of the first clamp jaw. Similarly, more than one clamp pad may be placed in contact with the ferrous contact surface of the contact head. One or more clamp pads may be placed in contact with any ferrous surface of the clamp. In the embodiment shown in FIG. 5, the first clamp pad and the second clamp pad remain magnetically attached to the ferrous contact surfaces of the clamp until the first clamp pad and the second clamp pad are removed from the clamp.

Either the top side or the bottom side of a clamp pad may be magnetically attached to any ferrous contact surface. Both the top and bottom sides of a clamp pad may be attached to different ferrous contact surfaces.

In the embodiment shown in FIG. 5, the work piece comprises two or more segments which the user desires to glue together into a single object. In this embodiment, the first clamp pad and the second clamp pad provide cushions between the ferrous contact surfaces and the work piece. The clamp pads increase the distance between the clamp jaws and the work piece, which leaves room for excess glue to be squeezed out from the work piece during the gluing operation, while still preventing contact between the clamp and the wet glue which can result in a stain on the work piece. The distance between the clamp jaws and the work piece further allows access to the work piece for removing excess glue before the glue dries. The user does not have to hold the clamp pads in place while applying tension to the clamp, because magnetism causes the clamp pads to adhere to the ferrous contact surfaces of the clamp. The resulting increase in efficiency may alleviate the mental stress that often accompanies gluing operations, as glue has a set up time that cannot be altered. The resulting savings of time in gluing operations is advantageous, and greatly increases the odds of a successful operation. Use of the present system, method, and apparatus may also reduce the amount of labor (including without limitation the number of workers) needed for a gluing operation, as well as reducing or eliminating the damage caused by using conventional clamping systems and methods.

In the embodiments shown in FIGS. 1-9, the clamp pads have a firm, smooth, slick surface on both the top and bottom sides. This allows the user to slide the clamp pads easily so that one or more clamp pads can be placed in contact with one or more ferrous contact surfaces of the clamp, then adjusted as desired. Adjustment of the one or more clamp pads may allow clamp tension to be absorbed, distributed, and/or directed through the one or more clamp pads onto the work piece. Adjustment of the one or more clamp pads may change the direction of the clamp tension, which is often required during a gluing operation.

The firm, smooth, slick surface of each clamp pad may allow easy separation of one clamp pad from another clamp pad. For example and without limitation, sliding the bottom of a first clamp pad parallel to the top of a second clamp pad adjacent to the first clamp pad, may allow easy separation of the first clamp pad from the second clamp pad.

The present inventive system, method, and apparatus may allow the user to orient one or more clamps around a work piece and to position one or more clamp pads on the one or more clamps in advance of a gluing operation. (“Staging”, used in this disclosure, refers to this procedure.) One or more clamp pads may also be used with no staging necessary, by attaching the one or more clamp pads to one or more ferrous contact surfaces as needed or desired.

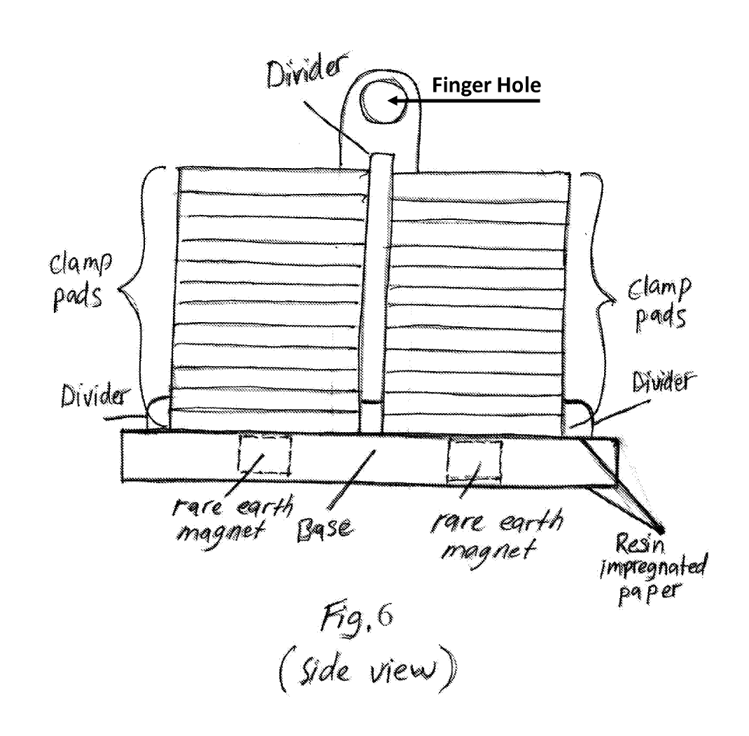

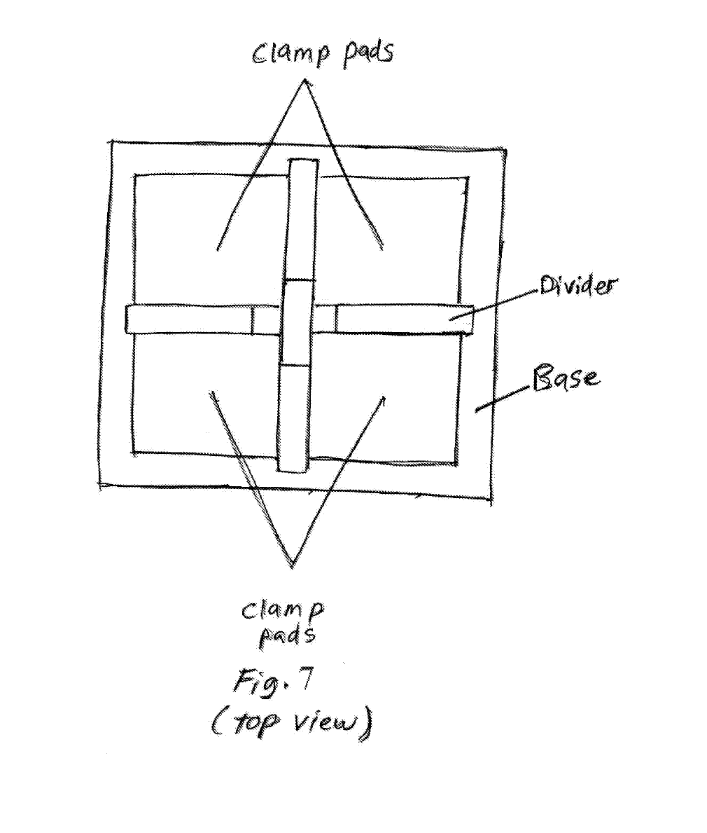

The plurality of clamp pads may be stored on a storage rack. The storage rack may be portable or in a fixed location. In the embodiment shown in FIGS. 6 and 7, the storage rack is portable and comprises a divider and a base. A user may carry the portable storage rack to any particular location to aid in a gluing operation.

In the embodiment shown in FIGS. 6 and 7, a plurality of rare earth magnets is embedded within the base, to allow one or more clamp pads to adhere magnetically to the base. The illustrated embodiment allows the user to place four stacks of clamp pads onto the base of the storage rack. The rare earth magnets in the base, as well as in each of the clamp pads, may cause the clamp pads to adhere tightly to one another, as well as to the base, until the clamp pads are removed from the base by the user. This may allow for easier transportation of the clamp pads that are magnetically attached to the base of the storage rack.

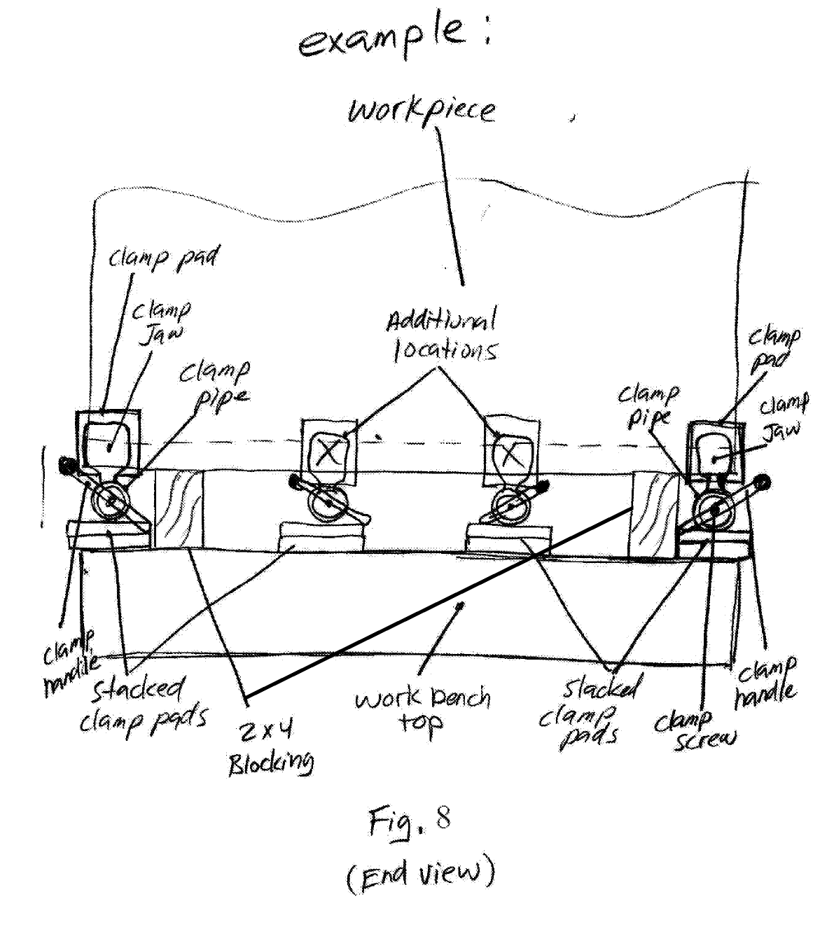

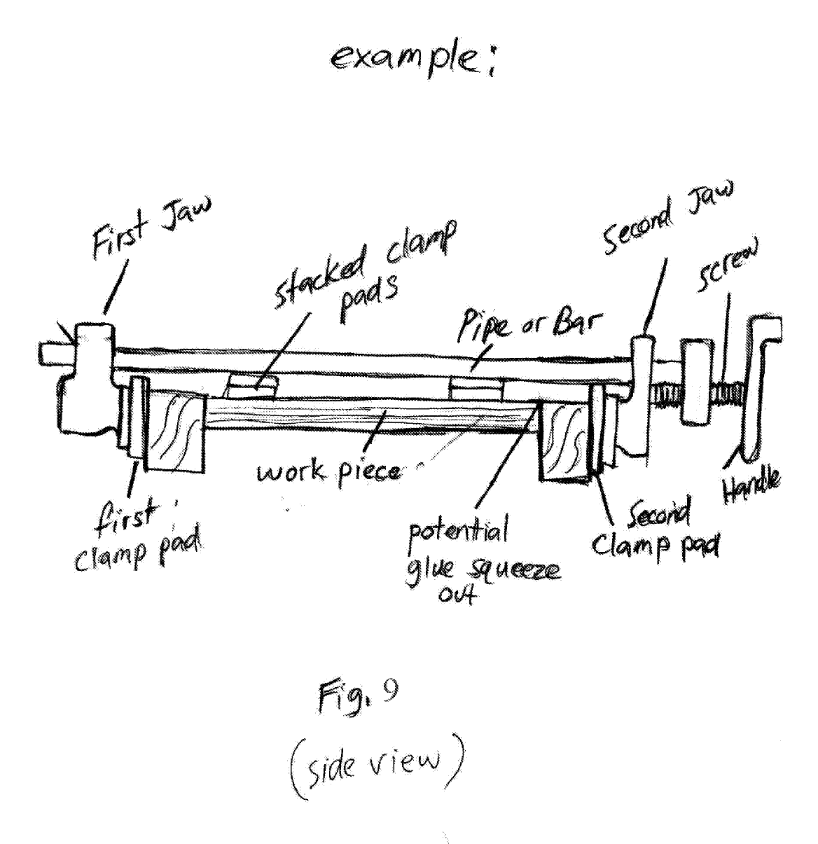

The present inventive system, method, and apparatus may allow a user to remove one or more clamp pads from a stack by sliding the bottom of the lowest clamp pad (i.e., the desired clamp pad that is closest to the base of the storage rack) parallel to the top of the clamp pad below the lowest clamp pad and away from the divider. This may allow the user to obtain the desired number of clamp pads without causing any of the remaining clamp pads to detach from the storage rack. FIGS. 8 and 9 show an example of the present inventive system, method, and apparatus used in a workplace. In the embodiment shown in FIG. 9, stacked clamp pads provide cushions between a pipe (or bar) and the work piece. Additionally, a first clamp pad and a second clamp pad provide cushions between the clamp jaws and the work piece. This allows the clamp to bend under tension, thereby preventing potential damage to the work piece surface. The stacked clamp pads also increase the distance between the pipe (or bar) and the work piece, which leaves room for excess glue to be squeezed out from the work piece during the gluing operation.

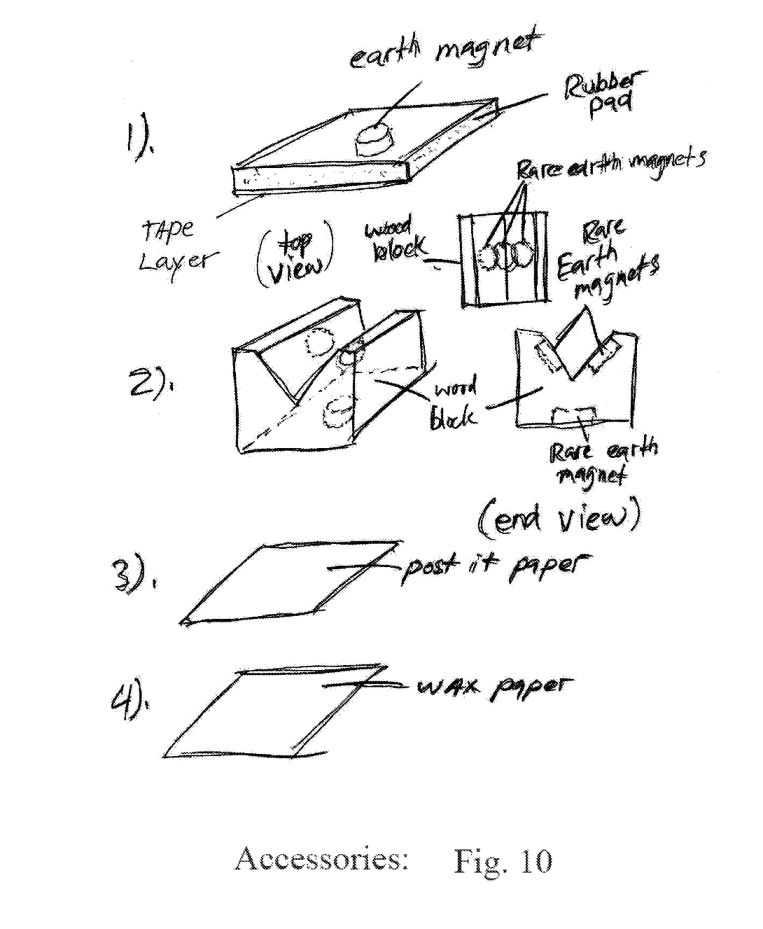

FIG. 10 illustrates various embodiments of accessories that may be used in connection with the present inventive system, method, and apparatus. The drawing at the top of FIG. 10 illustrates one embodiment of a rigid foam rubber pad that may act as a non skid surface when attached to the top surface of a clamp pad. In the embodiment shown, the rubber pad also contains one or more magnets. The one or more magnets may be of different dimensions than the magnets used inside clamp pads. In this embodiment, the rubber pad has the same dimensions as the clamp pad to which it is attached. The rubber pad may act as a non skid surface when attached to the top surface of a clamp pad. One or more rubber pads may be used when elevating a work piece on a plurality of stacks of clamp pads for access to the underside of the work piece.

Immediately beneath the drawing of one embodiment of a rigid foam rubber pad at the top of FIG. 10, there is an illustration of one embodiment of a V-shaped block that contains one or more magnets. One or more V-shaped blocks may be attached directly to pipe style clamps and to clamp pads to elevate clamps off a work bench surface and to allow for gluing beneath a work piece when the work piece is elevated on 2×4 blocking.

Beneath the illustration of one embodiment of a V-shaped block on FIG. 10, there is an illustration of one embodiment of a Post-It®-style self stick sheet which may be used with a clamp pad to create a new surface for clamping pre-finished parts when greater protection is required.

Beneath the illustration of one embodiment of a Post-It®-style self stick sheet on FIG. 10, there is an illustration of one embodiment of a sheet of wax paper which can be used with a clamp pad to further limit the risk of glue contact with the work piece.

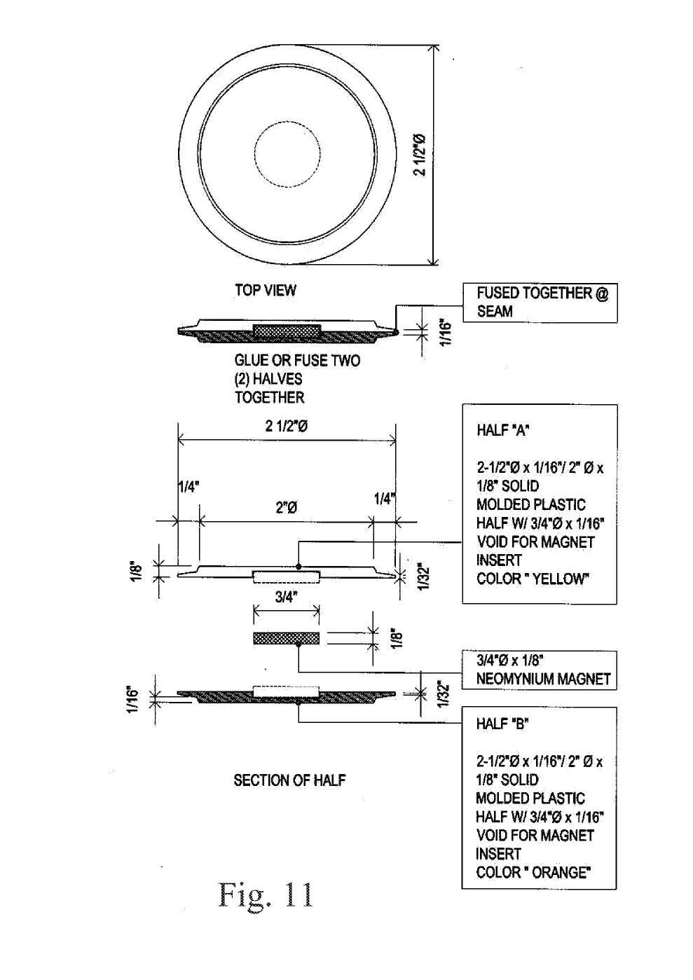

Referring now to FIG. 11, in another embodiment, a pad is shown having a more rounded shape. In this particular implementation the pad is 2.25 inches in diameter by 0.25 inches thick. In this embodiment, the clamp pad is comprised of two halves of injection molded plastic that will then be sealed together to in case a Rare Earth Disc Neodymium N42, 0.75 inches diameter by 0.125 inches thick. Each magnet may have strength of 10 pounds pull force. The clamp pad is made from two halves. Each half to be of a different or contrasting color to determine the polarity of the clamp pad once they are permanently sealed together, either with a glue, or fused together by heat.

The round shape of this embodiment makes it easier to apply the pads to the clamps because they are non directional, and storing them in the storage rack for the same reason. In addition, plastic is a non-stick material so wood glues do not adhere to the surfaces of the clamp pad as much. In addition, plastic has a slippery surface so that adjusting the clamp and clamp pad under pressure is much easier. The contrasting colored sides of the clamp pad allow for an instant recognition of the polarity so that stacking the clamp pads is easier. Still further, the production of the clamp pads is simple and cost effective, and the longevity of the pads is improved because of the durability of the material. The pull force of the magnet is also greater through plastic, which helps ensure better adhesion to the ferrous metal clamp. These and other advantages will be apparent to those skilled in the art.

As shown in FIG. 11, the profile of this embodiment demonstrates that each half of the pad is roughly 0.125 inches at the main body of the clamp pad; when fused together, the pad is roughly 0.25 inches thick. The outer perimeter of the pad is roughly 0.0625 inches thick by 0.125 inches deep leaving the main body of the pad roughly 2.0 inches in diameter by 0.25 inches thick. One advantage of the thinner outer perimeter is that when the pads are stacked, it creates a space between each pad for finger tips, making it easier to separate the pads.

Although specific embodiments of the invention have been shown and described in this patent application, those skilled in the art will appreciate that these specific embodiments are for illustrative purposes only and are not exhaustive of the many embodiments that may implement the invention. Accordingly, the scope of the invention is limited only by the claims of this patent.

What is claimed is:

1. An apparatus to clamp a workpiece, comprising:
a clamp pad having a body, the body having an outside and an inside, the body being of relatively flat shape, the body having a surface that is substantially smooth, the inside of the body having a cavity in which is disposed a magnet,
wherein the clamp pad may be adhered to a clamp using the magnetic force of the magnet.

2. An apparatus for clamping a workpiece in a clamp, comprising:
means for cushioning the workpiece from the clamp.

3. A method of manufacturing a clamp pad, comprising:
making a clamp pad having an outside and an inside, the clamp pad being of relatively flat shape and having a surface that is substantially smooth; and
disposing a magnet within the body such that a magnetic field generated by the magnet is sufficient to extend outside the clamp pad;
wherein the clamp pad may be adhered to a clamp using the magnetic field of the magnet.
